(19) United States
(12) Patent Application Publication
(10) Pub. No.: US 2022/0156677 A1
(43) Pub. Date: May 19, 2022

(54) PROCESS MANAGEMENT SYSTEM, PROCESS MANAGEMENT METHOD, AND PROGRAM

(71) Applicant: PANASONIC INTELLECTUAL PROPERTY MANAGEMENT CO., LTD., Osaka (JP)

(72) Inventors: Masataka HAYASHI, Aichi (JP); Masashi NAKAYAMA, Kyoto (JP); Tomoyuki ICHIKAWA, Osaka (JP)

(21) Appl. No.: 17/421,136

(22) PCT Filed: Dec. 13, 2019
(86) PCT No.: PCT/JP2019/048850

§ 371 Date: Jul. 7, 2021

(30) Foreign Application Priority Data
Jan. 9, 2019 (JP) 2019-002218

(51) Int. Cl. G06Q 10/06; G06V 40/20

(52) U.S. Cl. CPC G06Q 10/063114; G06V 40/20; G06Q 10/06395

(57) ABSTRACT

A process management system includes a first acquirer, a second acquirer, and a processing unit. The first acquirer is configured to acquire first time information on an amount of time for which a person is present in a work area. The second acquirer is configured to acquire second time information on an amount of motion time for which the person makes a prescribed motion in the work area. The processing unit acquires, in accordance with the first time information and the second time information, work information on work which the person carries out, the work including the prescribed motion.

### TECHNICAL FIELD

The present disclosure generally relates to process management systems, process management methods, and programs. The present disclosure specifically relates to a process management system, a process management method, and a program which manage processes of work which a person carries out.

### BACKGROUND ART

Patent Literature 1 discloses a facility operating ratio monitor configured to record the operation state of a production facility. The facility operating ratio monitor is electrically connected the production facility, monitors the operation state of the production facility, and records operation data. The facility operating ratio monitor includes a detection sensor unit and an operating ratio monitor body. The detection sensor unit is configured to convert a signal, such as a sound or light, of the production facility into an electrical signal. The operating ratio monitor body is configured to sum up the operation data in accordance with the electrical signal output from the detection sensor unit.

In the case of the facility operating ratio monitor described in Patent Literature 1, it is possible to record the operation state of the production facility, but it is not possible to know the state of work which a person carries out.

### CITATION LIST

### Patent Literature

Patent Literature 1: JP 2001-100820 A

### SUMMARY OF INVENTION

It is an object of the present disclosure to provide a process management system, a process management method, and a program by which the state of work which a person carries out is easily known.

A process management system according to an aspect of the present disclosure includes a first acquirer, a second acquirer, and a processing unit. The first acquirer is configured to acquire first time information on an amount of time for which a person is present in a work area. The second acquirer is configured to acquire second time information on an amount of motion time for which the person makes a prescribed motion in the work area. The processing unit is configured to acquire, in accordance with the first time information and the second time information, work information on work which the person repeatedly carries out, the work including the prescribed motion.

A process management method according to another aspect of the present disclosure includes a step of acquiring first time information on an amount of time for which a person is present in a work area. The process management method includes a step of acquiring second time information on an amount of motion time for which the person makes a prescribed motion in the work area. The process management method includes a step of acquiring, in accordance with the first time information and the second time information, work information on work which the person repeatedly carries out, the work including the prescribed motion.

A program according to one aspect of the present disclosure is a program configured to cause one or more processors to execute the process management method.

### BRIEF DESCRIPTION OF DRAWINGS

FIG. 1 is a block diagram illustrating a schema of a process management system according to an embodiment of the present disclosure:

FIG. 2 is a view schematically illustrating a work area where the process management system is used;

FIG. 3 is a flowchart illustrating an example of motion of the process management system;

FIG. 4 is a view illustrating an example of first statistical data output from an outputter of the process management system;

FIGS. 5A and 5B are each a view illustrating an example of second statistical data output from the outputter;

FIGS. 6A and 6D are each a view illustrating an example of third statistical data output from the outputter;

FIG. 7 is a view illustrating an example of fourth statistical data output from the outputter;

FIG. 8 is a view illustrating another example of the fourth statistical data output from the outputter;

FIG. 9 is a view illustrating an example of fifth statistical data output from the outputter;

FIGS. 10A and 10B are each a view illustrating an example of sixth statistical data output from the outputter;

FIGS. 11A and 11B are each a view illustrating an example of seventh statistical data output from the outputter;

FIGS. 12A and 12B are each a view illustrating another example of the seventh statistical data output from the outputter; and

FIG. 13 is a view illustrating an example of eighth statistical data output from the outputter.

### DESCRIPTION OF EMBODIMENTS

### (1) Schema

A process management system of the present embodiment is used to manage a process including work which a person carries out. The “person” mentioned in the present disclosure is a worker who engages in manufacturing products in a facility such as a factory. Moreover, the “work” mentioned in the present disclosure is work which a person repeatedly carries out to produce products. That is, when one product is assumed to be produced through work in one or more steps, a plurality of products are sequentially produced by the work which a person repeatedly carries out in each step. Examples of the work which a person carries out may include work in a cellular manufacturing system or work in a line manufacturing system. Moreover, the work in the cellular manufacturing system may include work in a system, a so-called single-person production system, in which one worker finishes a product. In the present embodiment, the work which a person carries out is described as the work in the single-person production system.

The process management system is used, for example, to analyze work which a person carries out in a facility, that is, to conduct an Industrial Engineering (IE) analysis. For example, the process management system is also used to improve a QC chart.

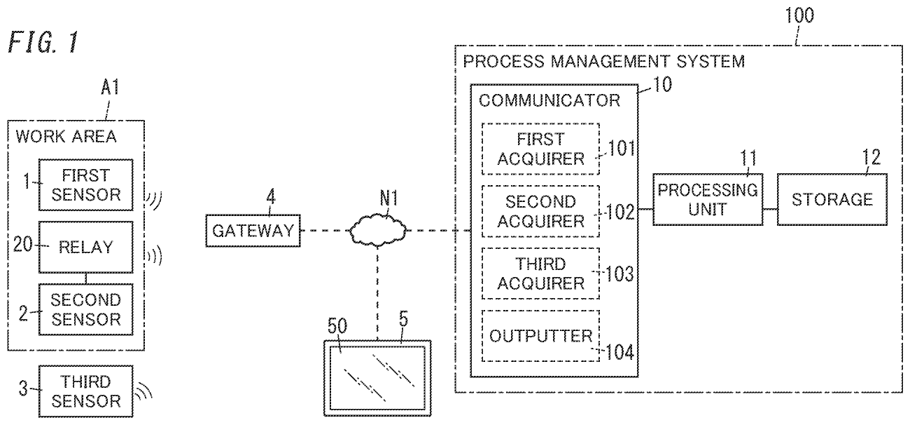

As illustrated in FIG. 1, a process management system 100 includes a first acquirer 101, a second acquirer 102, and a processing unit 11.

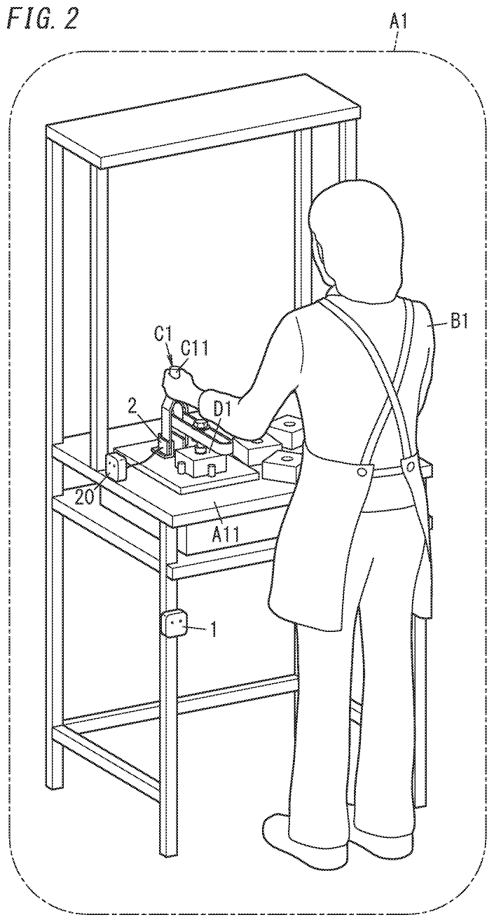

The first acquirer 101 acquires first time information on an amount of time for which a person B1 (see FIG. 2) is present in a work area A1. The “work area” mentioned in the present disclosure is an area where the person B1 carries out work in the facility. In the present embodiment, the work area A1 is an area including a worktable A11 (see FIG. 2) at which the person B1 carries out the work. Note that in the facility, people B1 carry out units of work at respective worktables A11, and therefore, the plurality of worktables A11 are provided. In this case, the work area A1 is an area which includes one worktable A11 of the plurality of worktables A11 and which does not include other worktables A11. Note that the person B1 is not limited to a specific one worker but may include a plurality of workers when the plurality of workers carry out units of work at one worktable A11. Moreover, the “first time information” mentioned in the present disclosure may be a time period from when the person B1 enters the work area A1 to when the person B1 leaves the work area A1, or a time at which the person B1 enters the work area A1, and/or a time at which the person B1 leaves the work area A1.

The second acquirer 102 acquires second time information on an amount of motion time for which the person B1 makes a prescribed motion in the work area A1. The “prescribed motion” mentioned in the present disclosure is a motion included in the work which the person B1 repeatedly carries out, may be a motion made by the person B1 himself/herself, or may be a motion of a jig C1 (see FIG. 2) used by the person B1 to carry out the work. Moreover, the “second time information” mentioned in the present disclosure may be an amount of time required for the prescribed motion or may be a start time of the prescribed motion and/or an end time of the prescribed motion. Moreover, the prescribed motion may be a single motion or, for example, one or more motions of two or more motions required for the work in one process.

The processing unit 11 acquires, in accordance with the first time information and the second time information, work information on the work which the person B1 repeatedly carries out, the work including the prescribed motion. For example, the first acquirer 101 is assumed to continue acquiring, as the first time information, the time period from when the person B1 enters the work area A1 to when the person B1 leaves the work area A1. In this case, the processing unit 11 acquires an amount of time for which the person B1 stays in the work area A1 as a time period (work information) during which the person B1 can carry out the work. Moreover, for example, the second acquirer 102 is assumed to continue acquiring the start time and the end time of the prescribed motion as the second time information. In this case, the processing unit 11 acquires an interval between start times of the prescribed motion as an amount of time (work information) required for the person B1 to carry out the work.

In the present embodiment, the work information on the work which the person B1 repeatedly carries out in the work area A1 is acquired, as described above, in accordance with the first time information and the second time information. Thus, the present embodiment has the advantage that the state of the work which the person B1 carries out is more easily known than in the case where only the amount of motion time of the production facility (including the jig C1) is acquired.

### (2) Details

With reference to FIGS. 1 and 2, the process management system 100 of the present embodiment will be described in detail. In the present embodiment, the process management system 100 manages work which each of people B1 carries out, but the description below is focused on management of work which one person B1 of the people B1 carries out unless otherwise indicated.

(2.1) Facility of Work Area

First of all, a facility used in the work area A1 to which the process management system 100 is applied will be described in detail with reference to FIGS. 1 and 2. In the present embodiment, the work area A1 is an area including one worktable A11 at which the person B1 carries out the work in the single-person production system as described above. In the work area A1, a first sensor 1, a second sensor 2, and a relay 20 are installed. Moreover, around the work area A1, a third sensor 3 and a gateway 4 are installed. The third sensor 3 and the gateway 4 may each be installed in the work area A1.

In the present embodiment, none of the first sensor 1, the second sensor 2, the relay 20, the third sensor 3, and the gateway 4 is included in components of the process management system 100. However, the first sensor 1, the second sensor 2, the relay 20, the third sensor 3, and the gateway 4 may be included in the components of the process management system 100. For example, the process management system 100 may further include the first sensor 1 and the second sensor 2.

The first sensor 1 is a reflection-type photoelectric sensor and is installed on the worktable A11. Specifically, the first sensor 1 is installed at a location which is part of a leg of the worktable A11 as illustrated in FIG. 2 and where the first sensor 1 can project light, such as an infrared ray, toward a space where the person B1 is present when the person B1 carries out the work at the worktable A11. The first sensor 1 projects light from its light emitting unit toward the space and detects the presence or absence of reflected light by its light receiving unit to determine whether or not the person B1 is present in the work area A1. Specifically, the first sensor 1 determines that the person B1 is present in the work area A1 if the light receiving unit receives the reflected light at a prescribed quantity or greater, and the first sensor 1 otherwise determines that the person B1 is absent from the work area A1. In this case, the first sensor 1 may be, for example, an element including the light emitting unit and the light receiving unit integrated with each other. Moreover, in this case, circuits constituting the light emitting unit, the light receiving unit, and the like of the first sensor 1 may be accommodated in one housing.

The first sensor 1 includes a wireless communication module which performs, with the gateway 4, optical wireless communication using light such as infrared radiation or visible radiation as a medium or wireless communication using a radio wave as a medium. The first sensor 1 transmits a sensing result by the first sensor 1 to the gateway 4 via the wireless communication module. For example, when the sensing result by the first sensor 1 is represented by a binary signal, the signal value of the binary signal corresponds to a high level while the presence of the person B1 is being detected, whereas the signal value of the binary signal corresponds to a low level while the presence of the person B1 is not being detected. Note that the levels of the binary signal may be inverted. The first sensor 1 and the gateway 4 are connected via a network different from a network existing in the facility.

The second sensor 2 is a contact point (contact) sensor or a non-contact sensor based on magnetism, a radio wave, light, or the like and is installed on the worktable A11. In the present embodiment, the second sensor 2 is attached to, for example, the jig C1 or the like to be used at the worktable A11 by the person B1. The jig C1 is used by being operated at least once per work which the person B1 repeatedly carries out. In the present embodiment, the jig C1 is, for example, a toggle clamp for fixing a component D1.

The second sensor 2 detects movement of a lever C11 included in the jig C1, thereby detecting the prescribed motion made by the person B1 in the work area A1. In this embodiment, the lever C11 of the jig C1 is configured to be movable between a first location and a second location. When the lever C11 is at the first location, the jig C1 is in a state where the jig C1 does not fix the component D1, that is, in a state where the jig C1 is not used. When the lever C11 is at the second location, the jig C1 is in a state where the jig C1 fixes the component D1, that is, in a state where the jig C1 is used. When the person B1 carries out the work, the person B1 grasps the lever C11 to move the lever C11 from the first location to the second location, thereby using the jig C1. Thus, the second sensor 2 detects the movement of the lever C11, thereby detecting the prescribed motion (motion of moving the lever C11) made by the person B1 in the work area A1. Specifically, if the lever C11 is in the second location, the second sensor 2 determines that the prescribed motion is made, whereas if the lever C11 is in the first location, the second sensor 2 determines that the prescribed motion is not made.

The second sensor 2 includes a wired communication module which performs wired communication with the relay 20 via a communication cable. The second sensor 2 transmits a sensing result by the second sensor 2 to the relay 20 via the wired communication module. Note that the configuration of the second sensor 2 is not limited to a configuration which performs the wired communication but may be a configuration which performs near field communication. For example, when the sensing result by the second sensor 2 is represented by a binary signal, the signal value of the binary signal corresponds to a high level while the prescribed motion is being detected, whereas the signal value of the binary signal corresponds to a low level while the prescribed motion is not being detected. Note that the levels of the binary signal may be inverted.

The relay 20 includes: a connection interface which enables wired or wireless connection of one or more second sensors 2; and a wireless communication module. In the present embodiment, the wired connection of one or more second sensors 2 is achieved by connecting the one or more second sensors 2 to the connection interface of the relay 20 via a communication cable. Note that the relay 20 may have a configuration in which the plurality of second sensors 2 are connected based on a communication scheme using a bus line or the like. The wireless communication module performs, with the gateway 4, optical wireless communication using light such as infrared radiation or visible radiation as a medium or wireless communication using a radio wave as a medium. The relay 20 has a function of transmitting (relaying), to the gateway 4, one or more sensing results respectively transmitted from the one or more second sensors 2 connected to the relay 20. Note that the relay 20 and the gateway 4 are connected via a network different from a network existing in the facility. In the present embodiment, the network is the same as the network between the first sensor 1 and the gateway 4.

The third sensor 3 is a photosensor and includes a light receiving unit configured to receive light emitted from Signal Tower (registered trademark). The Signal Tower (registered trademark) includes a plurality of lamps aligned in tower form and is installed in the facility. The Signal Tower (registered trademark) is used to visually inform surroundings of the operational status of a corresponding production facility. For example, the Signal Tower (registered trademark) includes a first lamp which emits green light, a second lamp which emits yellow light, and a third lamp which emits red light.

In the present embodiment, the Signal Tower (registered trademark) is directed to, for example, a plurality of worktables A11. The Signal Tower (registered trademark) turns on the first lamp when work is normally carried out at the plurality of worktables A11, turns on the second lamp when the work is interrupted at any of the worktables A11, and turns on the third lamp when the work is interrupted at all of the worktables A11. The third sensor 3 detects work statuses at the plurality of worktables A11 by receiving light emitted from the first lamp, the second lamp, or the third lamp.

The third sensor 3 includes a wireless communication module which performs, with the gateway 4, optical wireless communication using light such as infrared radiation or visible radiation as a medium or wireless communication using a radio wave as a medium. The third sensor 3 transmits a sensing result by the third sensor 3 to the gateway 4 via the wireless communication module. For example, it is assumed that a signal representing the sensing result by the third sensor 3 may have any one of three values, namely, a first value, a second value, and a third value. In this case, the signal has the first value when the first lamp is lit, the signal has the second value when the second lamp is lit, and the signal has the third value when the third lamp is lit. The third sensor 3 and the gateway 4 are connected via a network different from a network existing in the facility. In the present embodiment, the network is the same as the network between the first sensor 1 and the gateway 4.

The gateway 4 has a function of transmitting data received from each of the first sensor 1, the relay 20, and the third sensor 3, for example, via a network N1, such as the Internet, to a communicator 10 (which will be described later) of the process management system 100. In the present embodiment, the gateway 4 is a wireless communication module configured to be connected to the network N1 via a mobile phone network (a carrier network) provided by, for example, a communication business operator. Examples of the mobile phone network include a third generation (3G) network, a fourth generation (4G) network, or a fifth generation (5G) network. In addition, the gateway 4 may perform wireless communication with the communicator 10 based on a wireless communication scheme compliant with a standard such as, WiFi (registered trademark). In this case, part or the entirety of the communication between the gateway 4 and the communicator 10 is implemented by the network N1 different from a network existing in the facility. Note that when Local Area Network (LAN) wiring or the like existing in the facility is located in the vicinity of the worktable A11, the gateway 4 may communicate with the communicator 10 via the LAN wiring.

(2.2) Process Management System

Next, the configuration of the process management system 100 will be described with reference to FIG. 1. In the present embodiment, the process management system 100 is implemented by a processing device and the like provided in a remote location away from the installation location of the plurality of worktables A11. The processing device is, for example, a server. In the present embodiment, the process management system 100 is provided outside the facility but may be provided in the facility. The process management system 100 includes the communicator 10, the processing unit 11, and the storage 12 as illustrated in FIG. 1. In the present embodiment, the storage 12 is assumed to be included in the components of the process management system 100, but the storage 12 does not have to be included in the components of the process management system 100.

The communicator 10 is, for example, a communication module configured to be connected to the network N1 via the mobile phone network or the like. Note that the communicator 10 is preferably a wireless communication module configured to be wirelessly connected to the network N1. The communicator 10 has a function of communicating with the gateway 4 via the network N1 and a function of communicating with the terminal 5 via the network N1. In this embodiment, the terminal 5 is, for example, a terminal used by an administrator of the process management system 100 (or an administrator of the facility) and is for example, a smartphone or a tablet computer. Alternatively, the terminal 5 may be, for example, a desktop or laptop personal computer. In the present embodiment, the terminal 5 is, for example, a tablet computer including a display section 50 such as a liquid crystal display.

The communicator 10 has functions as the first acquirer 101, the second acquirer 102, a third acquirer 103, and an outputter 104.

The first acquirer 101 acquires the sensing result by the first sensor 1 via the gateway 4 and the network N1. In the present embodiment, the first acquirer 101 acquires the sensing result by the first sensor 1 and a time stamp relating to a time at which the person B1 is detected by the first sensor 1 in association with each other. As used herein, “the time at which the person B1 is detected” is a time at which the person B1 enters the work area A1 and/or a time at which the person B1 leaves the work area A1. That is, the first acquirer 101 acquires the first time information on an amount of time for which the person B1 is present in the work area A1. Then, the first time information includes a time stamp relating to an acquisition time (a time at which the person B1 is detected by the first sensor 1). In the present embodiment, the time stamp is added at a time point, for example, at which the gateway 4 acquires the sensing result by the first sensor 1. Thus, the time represented by the time stamp is, strictly speaking, different from, but basically corresponds to, a time at which the sensing result is acquired by the first sensor 1.

The second acquirer 102 acquires the sensing result by the second sensor 2 via the relay 20, the gateway 4, and the network N1. In the present embodiment, the second acquirer 102 acquires the sensing result by the second sensor 2 and a time stamp relating to a time at which the prescribed motion is detected by the second sensor 2 in association with each other. As used herein, the “time at which the prescribed motion is detected” is the start time of the prescribed motion and/or the end time of the prescribed motion. That is, the second acquirer 102 acquires second time information on an amount of motion time for which the person B1 makes a prescribed motion in the work area A1. Then, the second time information includes a time stamp relating to an acquisition time (the time at which the prescribed motion is detected by the second sensor 2). In the present embodiment, the time stamp is added at a time point, for example, at which the gateway 4 acquires the sensing result by the second sensor 2. Thus, the time represented by the time stamp is, strictly speaking, different from, but basically corresponds to, a time at which the sensing result is acquired by the second sensor 2.

In the present embodiment, the second sensor 2 detects the movement of the lever C11 included in the jig C1 as described above. Thus, the time at which the prescribed motion is detected by the second sensor 2 corresponds to a time at which the motion of the jig C1 (or the person B1) is detected. That is, in the present embodiment, the second acquirer 102 acquires, as the second time information, a motion time of the jig C1 (a start time and/or an end time of the motion of the jig C1) used in the work area A1, an amount of motion time required for the person B1 to carry out the work, or the like.

Moreover, in the present embodiment, the first time information and the second time information each include a time stamp as described above. In other words, at least one of the first time information or the second time information includes a time stamp regarding the acquisition time.

Here, the first sensor 1 and the relay 20 of the present embodiment each include a unique identifier. The first sensor 1 and the relay 20 respectively transmit, to the gateway 4, the sensing results by the first sensor 1 and the sensing result by the second sensor 2 inclusively of the respective identifiers. Thus, the first time information acquired by the first acquirer 101 includes the identifier of the first sensor 1. Similarly, the second time information acquired by the second acquirer 102 includes the identifier of the relay 20. The first sensor 1 and the relay 20 are each installed on the worktable A11, and therefore, these identifiers substantially correspond to identifier of the people B1 who carries out the work at the worktable A11. That is, the first acquirer 101 and the second acquirer 102 respectively acquire the first time information and the second time information individually for each person B1.

The third acquirer 103 acquires the sensing result by the third sensor 3 via the gateway 4 and the network N1. In the present embodiment, the third acquirer 103 acquires the sensing result by the third sensor 3 and a time stamp relating to a time at which the work statuses at the plurality of worktables A11 is detected by the third sensor 3 in association with each other. In the present embodiment, the time stamp is added at a time point, for example, at which the gateway 4 acquires the sensing result by the third sensor 3. Thus, the time represented by the time stamp is, strictly speaking, different from, but basically corresponds to, a time at which the third sensor 3 acquires the sensing result.

The outputter 104 transmits data to the terminal 5 via the network N1. The data includes the work information acquired by the processing unit 11 and is displayed on the display section 50 by a Graphical User Interface (GUI) of the terminal 5. That is, the outputter 104 outputs the work information as data to be visually displayed on the display section 50. In the present embodiment, the display section 50 of the terminal 5 does not display the work information as it is but displays statistical data obtained by statistical processing (which will be described later) performed by the processing unit 11 based on the work information. That is, the outputter 104 outputs the work information not directly but indirectly as data to be displayed on the display section 50. The statistical data will be described in detail later in “(4) Examples of Statistical Data”.

The processing unit 11 is a computer system including one or more processors and a memory as main hardware components. In the processing unit 11, a program stored in the memory is executed by the one or more processors to implement various functions. The program may be stored in the memory of the processing unit 11 in advance, may be provided over a telecommunications network, or may be provided as a non-transitory recording medium such as an optical disc or hard disk drive which stores the program and which is readable by the computer system.

The processing unit 11 can acquire, in accordance with the first time information acquired by the first acquirer 101, information such as an amount of time for which the person B1 stays in the work area A1 (hereinafter referred to also as an “attendance time”), an amount of time for which the person B1 is away from the work area A1 (hereinafter referred to also as an “absence time”), or the number of times that the person B1 leaves. Moreover, the processing unit 11 can acquire, based on the second time information acquired by the second acquirer 102, an amount of time required for the prescribed motion (in this embodiment, used hours of the jig C1) or the number of times of the prescribed motion (in this embodiment, the number of times of use of the jig C1). In the present embodiment, an example is described in which it is assumed that single work includes a single prescribed motion, and the single work is carried out for a single product. In this case, the processing unit 11 acquires the number of times of the prescribed motion, thereby consequently obtaining the number of produced products.

The processing unit 11 acquires, as an amount of time for which the person B1 carries out work (hereinafter referred to also as “working hours”), an amount of time from the start time of the motion of the jig C1 for work to the start time of the motion of the jig C1 for next work. That is, in the normal mode, the person B1 cyclically repeats the work including the prescribed motion. Thus, the cycle of the prescribed motion basically corresponds to the cycle of the work, in other words, the working hours. Thus, the processing unit 11 acquires, in accordance with the first time information and the second time information, work information on the work which the person B1 repeatedly carries out, the work including the prescribed motion.

Here, as already described, the first acquirer 101 and the second acquirer 102 in the present embodiment respectively acquire the first time information and the second time information individually for each person B1. Thus, in the present embodiment, the processing unit 11 individually acquires the work information for each person B1 in accordance with the first time information and the second time information for individual person B1.

Moreover, the processing unit 11 acquires work statuses at the plurality of worktable A11 in accordance with information (the sensing result by the third sensor 3 and the time stamp) acquired by the third acquirer 103.

Moreover, the processing unit 11 has a function of executing statistical processing in accordance with the work information. Specifically, the processing unit 11 executes appropriate statistical processing in accordance with, for example, the attendance time, the absence time of the person B1, the used hours of the jig C1, and/or the amount of time required for the work, thereby generating pieces of statistical data as listed in “(4) Examples of Statistical Data”. The statistical processing may be regularly executed by the processing unit 11 or may be executed by using an output request as a trigger. As used herein, the “output request” is, for example, a command given to the process management system 100 from the terminal 5 via the network N1 by an operation given to the terminal 5 by an administrator. That is, when the administrator wishes to view the statistical data on the display section 50 of the terminal 5, the output request is given to the process management system 100.

The storage 12 includes, for example, at least one of a non-transitory recording medium such as a hard disk or a non-transitory recording medium such as a rewritable nonvolatile semiconductor memory. In the storage 12, the work information acquired by the processing unit 11 is stored in association with a corresponding person B1. That is, in the storage 12, respective pieces of work information are stored for the people B1. Moreover, in the storage 12, statistical data is stored which is acquired by executing the statistical processing by the processing unit 11. The work information and/or the statistical data stored in the storage 12 is/are read, for example, in accordance with the output request from the terminal 5.

### (3) Motion

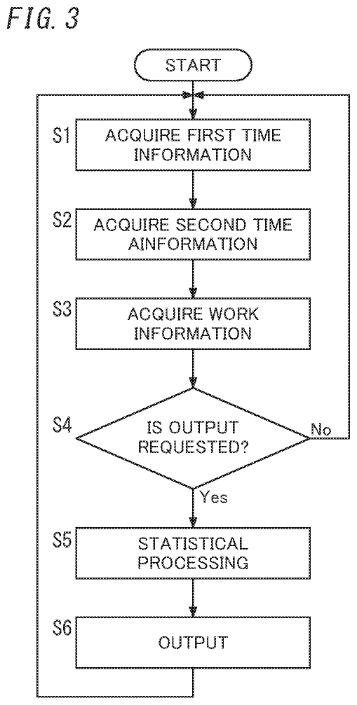

An example of the motion of the process management system 100 of the present embodiment will be described below with reference to FIG. 3. First of all, the sensing result by the first sensor 1 disposed in the work area A1 is regularly transmitted via the gateway 4 and the network N1 to the communicator 10. Thus, the first acquirer 101 regularly acquires the first time information including the sensing result by the first sensor 1 and the time stamp (S1). In addition, the sensing result by the second sensor 2 disposed in the work area A1 is regularly transmitted via the relay 20, the gateway 4, and the network N1 to the communicator 10. Thus, the second acquirer 102 regularly acquires the second time information including the sensing result by the second sensor 2 and the time stamp (S2). Then, the processing unit 11 regularly acquires the work information in accordance with the first time information acquired by the first acquirer 101 and the second time information acquired by the second acquirer 102 (S3). The work information thus acquired is stored in the storage 12.

Here, if no output request is given (S4: No), the process management system 100 repeats steps S1 to S3. In contrast, if the output request is given (S4: Yes), the processing unit 11 executes the statistical processing in accordance with the work information thus acquired (the work information stored in the storage 12) (S5). Thus, the processing unit 11 generates the statistical data according to the output request, that is, an operation input given to the terminal 5 by an administrator. Then, the processing unit 11 transmits the statistical data thus generated to the terminal 5 via the communicator 10 and the network N1. That is, the outputter 104 outputs the statistical data to the terminal 5 (S6). Hereafter, the process management system 100 repeats steps S1 to S6. Note that the process management system 100 may be configured to: execute the statistical processing each time the processing unit 11 acquires the work information; and store the result of the statistical processing in the storage 12. In this case, the processing unit 11 outputs the statistical data stored in the storage 12 to the terminal 5 when receiving the output request.

### (4) Examples of Statistical Data

Examples of the statistical data output from the outputter 104, in other words, examples of the statistical data to be displayed on the display section 50 of the terminal 5 will be listed below. The examples of the statistical data shown below are each data about one person B1. On the display section 50 of the terminal 5, one of the pieces of statistical data shown below may be displayed, or two or more pieces of statistical data of the pieces of statistical data may be displayed in combination.

(4.1) First Statistical Data

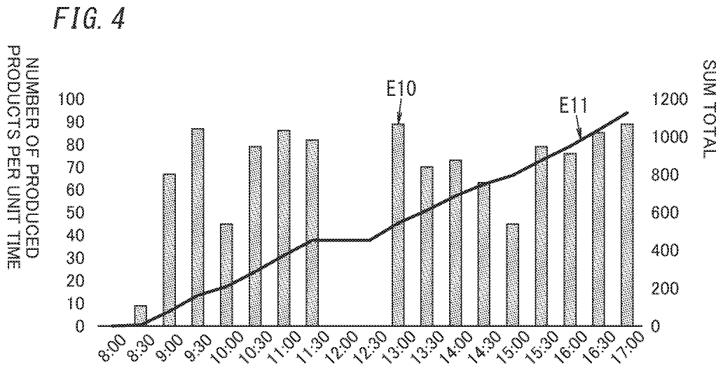

First statistical data represents a production history of products produced by the person B1 in one day. Specifically, as illustrated in FIG. 4, a bar graph E10 and a line graph E11 are displayed as first statistical data on the display section 50. The bar graph E10 is displayed on the display section 50, where the ordinate on the left represents the number of produced products per unit time (in this embodiment, per 30 minutes) and the abscissa represents the time. The line graph E11 is displayed on the display section 50, where the ordinate on the right represents a sum total of the number of produced products and the abscissa represents the time. For example, in FIG. 4, the person B1 produces about 10 products from 8:00 to 8:30. Moreover, in the example shown in FIG. 4, the person B1 produces no product from 11:30 to 12:30 because the person B1 takes a break.

The processing unit 11 calculates the number of times of the prescribed motion (i.e., the number of produced products) per unit time in accordance with the second time information and generates the first statistical data based on the thus calculated number of times of the prescribed motion per unit time.

The administrator views the first statistical data by using the terminal 5, and thereby, the administrator can know a production history of the person B1 per day, that is, the capacity of the person B1 to produce products per unit time. Moreover, the administrator views the first statistical data by using the terminal 5, and thereby, the administrator can know a time zone in which the number of produced products by the person B1 decreases, and therefore, the administrator can also use the first statistical data to search for any cause of the production decline.

(4.2) Second Statistical Data

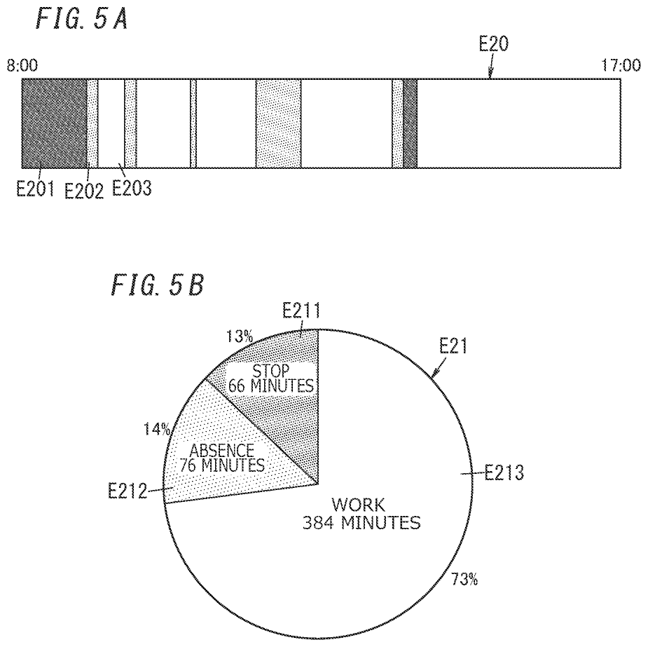

Second statistical data represents an activity history of the person B1 in one day. Specifically, a band graph E20 shown in FIG. 5A and a pie graph E21 shown in FIG. 5B are displayed as the second statistical data on the display section 50.

The band graph E20 is displayed on the display section 50 as illustrated in FIG. 5A such that one or more first areas E201, one or more second areas E202, and one or more third areas E203 are aligned in time sequence. The first area E201 represents an amount of time for which the person B1 stays in the work area A1 but does not carry out the work (hereinafter referred to also as a “non-working hours”). The second area E202 represents an amount of time for which the person B1 is away from the work area A1 (i.e., the absence time). The third area E203 represents an amount of time for which the person B1 stays in the work area A1 and carries out the work (i.e., the working hours).

Note that although omitted from FIG. 5A, the number of times of events that the person is absent for longer than or equal to a first prescribed time (e.g., for 5 minutes) and the number of times of events that the person is absent for longer than or equal to a second prescribed time (e.g., for 1 minute) are displayed on the display section 50 by character strings along with the band graph E20.

As illustrated in FIG. 5B, the pie graph E21 is displayed on the display section 50 in the form of a pie graph including a first area E211, a second area E212, and a third area E213. The first area E211 represents a sum total of the non-working hours of the person B1 in the one day. In the example shown in FIG. 5B, displayed in the first area E211 are a character string representing “stop”, a numerical value representing the sum total of the non-working hours, and a proportion of the sum total of the non-working hours to an activity time of the person B1. The second area E212 represents a sum total of the absence time of the person B1 in the one day. In the example shown in FIG. 5B, displayed in the second area E212 are a character string representing “absence”, a numerical value representing the sum total of the absence time, and a proportion of the sum total of the absence time to the activity time of the person B1. The third area E213 represents a sum total of the working hours of the person B1 in the one day. In the example shown in FIG. 5B, displayed in the third area E213 are a character string representing “work”, a numerical value representing a sum total of the working hours, and a proportion of the sum total of the working hours to the activity time of the person B1.

The processing unit 11 calculates, in accordance with the first time information, the amount of time for which the person B1 stays in the work area A1 (i.e., the attendance time) and the absence time. Moreover, the processing unit 11 calculates the non-working hours and the working hours in accordance with the attendance time thus calculated and the second time information. Then, the processing unit 11 generates the second statistical data in accordance with the absence time thus calculated, the non-working hours, and the working hours.

The administrator views the second statistical data by using the terminal 5, and thereby, the administrator can know the activity of the person B1. For example, the administrator knows the absence time and the non-working hours of the person B1, and thereby, the administrator can take measures to reduce the amount of time for which the person B1 does not carry out the work.

(4.3) Third Statistical Data

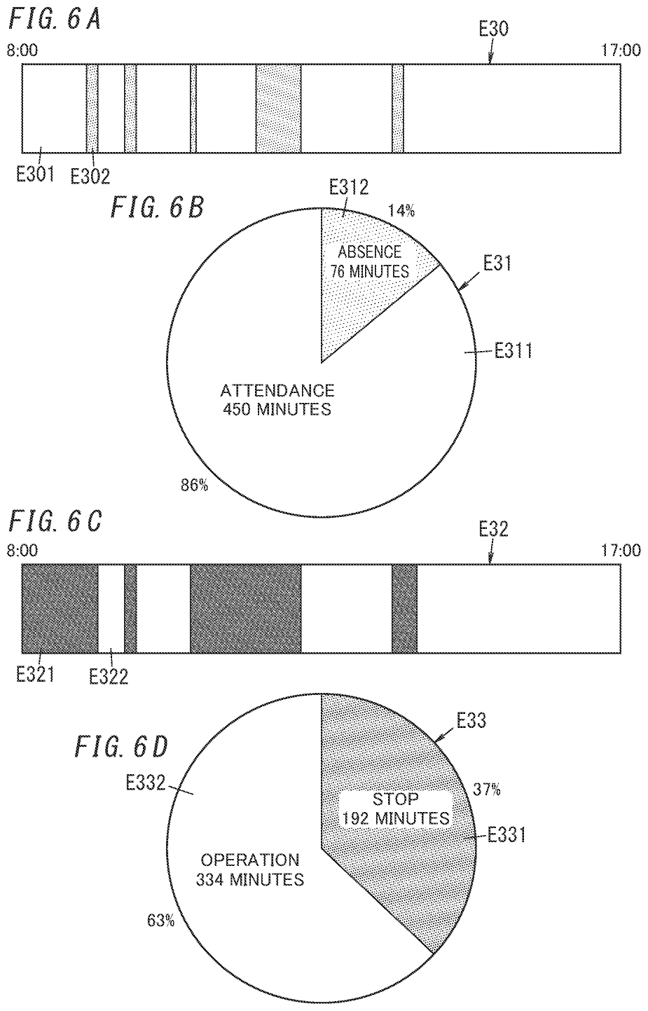

The third statistical data represents a history of the attendance time and the absence time of the person B1 in one day and a history of the working hours and the non-working hours in the one day. Specifically, a band graph E30 shown in FIG. 6A, a pie graph E31 shown in FIG. 6B, a band graph E32 shown in FIG. 6C, and a pie graph E33 shown in FIG. 6D are displayed as the third statistical data on the display section 50.

The band graph E30 is displayed on the display section 50 as illustrated in FIG. 6A such that one or more first areas E301 and one or more second areas E302 are aligned in time sequence. The first area E301 represents the attendance time of the person B1. The second area E302 represents the absence time of the person B1. Note that although omitted from FIG. 6A, the number of times that the person is absent for longer than or equal to the first prescribed time and the number of times that the person is absent for longer than or equal to the second prescribed time are displayed on the display section 50 by character strings along with the band graph E30.

As illustrated in FIG. 6B, the pie graph E31 is displayed on the display section 50 in the form of a pie graph including a first area E311 and a second area E312. The first area E311 represents a sum total of the attendance time of the person B1 in the one day. In the example shown in FIG. 6B, displayed in the first area E311 are a character string representing “attendance”, a numerical value representing the sum total of the attendance time, and a proportion of the sum total of the attendance time to the activity time of the person B1. The second area E312 represents the sum total of the absence time of the person B1 in the one day. In the example shown in FIG. 6B, displayed in the second area E312 are a character string representing “absence”, a numerical value representing the sum total of the absence time, and a proportion of the sum total of the absence time to the activity time of the person B1.

The band graph E32 is displayed on the display section 50 as illustrated in FIG. 6C such that one or more first areas E321 and one or more second areas E322 are aligned in time sequence. The first area E321 represents the non-working hours of the person B1. The second area E332 represents the working hours of the person B1. Note that although omitted from FIG. 6C, the number of times that the person does not carry out the work for longer than or equal to a prescribed time (e.g., for 5 minutes) and the number of times of the prescribed motion (i.e., the number of produced products) are displayed on the display section 50 by character strings along the band graph E32.

As illustrated in FIG. 6D, the pie graph E33 is displayed on the display section 50 in the form of a pie graph including a first area E331 and a second area E332. The first area E331 represents a sum total of the non-working hours of the person B1 in the one day. In the example shown in FIG. 6D, displayed in the first area E331 are a character string representing “stop”, a numerical value representing the sum total of the non-working hours, and a proportion of the sum total of the non-working hours to an activity time of the person B1. The second area E332 represents a sum total of the working hours of the person B1 in the one day. In the example shown in FIG. 6D, displayed in the second area E332 are a character string representing “operation”, a numerical value representing the sum total of the working hours, and a proportion of the sum total of the working hours to the activity time of the person B1.

In a similar manner to the case of generating the second statistical data, the processing unit 11 calculates the attendance time, the absence time, the non-working hours, and the working hours of the person B1 in accordance with the first time information and the second time information and generates the third statistical data in accordance with the pieces of data thus calculated.

The administrator views the third statistical data by using the terminal 5, and thereby, the administrator can know the activity of the person B1 as described above from an aspect different from the case where the administrator views the second statistical data.

(4.4) Fourth Statistical Data

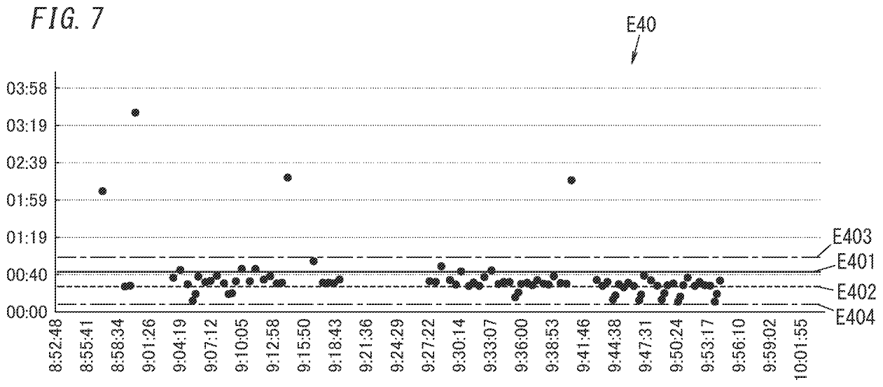

Fourth statistical data represents variations of the working hours of the person B1 in a specific time zone in one day. Specifically, as illustrated in FIG. 7, a scatter diagram E40 is displayed as the fourth statistical data on the display section 50, where the ordinate represents the working hours and the abscissa represents the time. FIG. 7 shows an example of the fourth statistical data, where a time zone from about 8:50 to about 10:00 is the specific time zone.

As illustrated in FIG. 7, the scatter diagram E40 is displayed on the display section 50 in the form of a scatter diagram including a first line E401, a second line E402, a third line E403, and a fourth line E404. The first line E401 represents an average value of the working hours of the person B1. Note that the first line E401 may represent a median value of the working hours of the person B1 instead of the average value of the working hours of the person B1. The second line E402 represents working hours in the case of the person B1 doing standard work, in other words, a target value of the working hours of the person B1. The third line E403 and the fourth line E404 each represent a threshold based on which the value of the working hours of the person B1 is classified into a normal value or an anomalous value (outlier). That is, when the value of the working hours is larger than an upper limit value which is the threshold represented by the third line E403 or smaller than a lower limit value which is the threshold represented by the fourth line E404, the processing unit 11 is to count the value of the working hours as the anomalous value.

In the present embodiment, the target value of the working hours of the person B1, the upper limit value as the threshold, and the lower limit value as the threshold are each set by the administrator in advance.

In a similar manner to the case of generating the second statistical data, the processing unit 11 calculates the working hours of the person B1 in accordance with the first time information and the second time information and generates the fourth statistical data in accordance with the working hours thus calculated. Note that the processing unit 11 may be configured to count the value of the working hours as the anomalous value when the value of the working hours is larger than the upper limit value as the threshold or smaller than the lower limit value as the threshold twice or more consecutively, or twice or more within a specified time period.

The administrator views the fourth statistical data by using the terminal 5, and thereby, the administrator can know the variations in the working hours of the person B1. Moreover, the administrator views the fourth statistical data by using the terminal 5, and thereby, the administrator can know an anomalous value of the working hours, in other words, the occurrence of any unusual event in the work, and therefore, the administrator can use the fourth statistical data to search for any cause of the occurrence of the unusual event to improve the work.

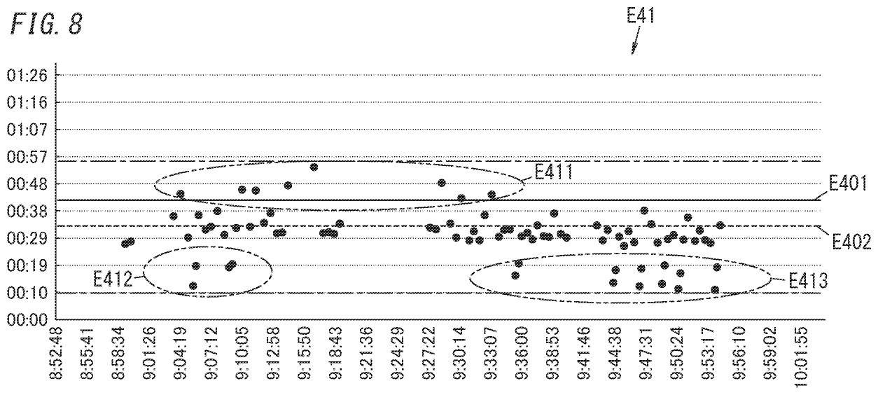

In this embodiment, the administrator may give a prescribed operation to the terminal 5 to view the fourth statistical data from a different aspect. Specifically, as illustrated in FIG. 8, the anomalous value of the working hours may be removed from the scatter diagram E40, and then, the scatter diagram E41 may be enlarged, and the scatter diagram E41 thus enlarged may be displayed as the fourth statistical data on the display section 50. In this case, the administrator can know the variations in the working hours of the person B1 with the anomalous value of the working hours being removed. In the example shown in FIG. 8, the values of the working hours included in areas E411, E412, and E413 encircled by long dashed double-short dashed lines are farther away from the target value of the working hours than other values of the working hours are. Thus, the administrator views the areas E411, E412, and E413, and thereby, and thereby, the administrator can take any measure to reduce the variations in the working hours.

(4.5) Fifth Statistical Data

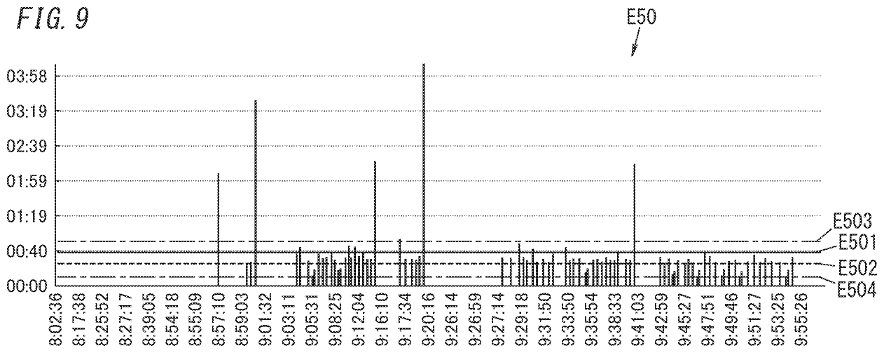

Fifth statistical data represents variations in the working hours of the person B1 in a specific time zone in one day in a similar manner to the fourth statistical data. Specifically, as illustrated in FIG. 9, a bar graph E50 is displayed as the fifth statistical data on the display section 50, where the ordinate represents the working hours and the abscissa represents the time. FIG. 9 shows an example of the fifth statistical data, where a time zone from about 8:00 to about 10:00 is the specific time zone.

As illustrated in FIG. 9, the bar graph E50 is displayed on the display section 50 in the form of a bar graph including a first line E501, a second line E502, a third line E503, and a fourth line E504. The first line E501, the second line E502, the third line E503, and the fourth line E504 respectively represent an average value of the working hours of the person B1, a target value of the working hours of the person B1, an upper limit value as a threshold, and a lower limit value as a threshold. Note that the first line E401 may represent a median value of the working hours of the person B1 instead of the average value of the working hours of the person B1 in a similar manner to the fourth statistical data. When the value of the working hours is larger than the upper limit value which is the threshold represented by the third line E503 or smaller than the lower limit value which is the threshold represented by the fourth line E504, the value of the working hours are to be counted as the anomalous value.

In a similar manner to the case of generating the second statistical data, the processing unit 11 calculates the working hours of the person B1 in accordance with the first time information and the second time information and generates the fifth statistical data in accordance with the working hours thus calculated.

The administrator views the fifth statistical data by using the terminal 5, and thereby, the administrator can know the variations in the working hours of the person B1 and/or know the occurrence of any unusual event in the work in a similar manner to the case where the administrator views the fourth statistical data.

(4.6) Sixth Statistical Data

Sixth statistical data represents variations in working hours in a specific time zone in one day in the case where two different types of prescribed motions are included in the work which the person B1 carries out. That is, in this embodiment, the work which the person B1 carries out is assumed to include: a first subtask which is carried out by using a first jig and a second subtask which is carried out by using a second jig. The movement of the first jig and the movement of the second jig can be detectable by installing two different second sensors 2 in the work area A1.

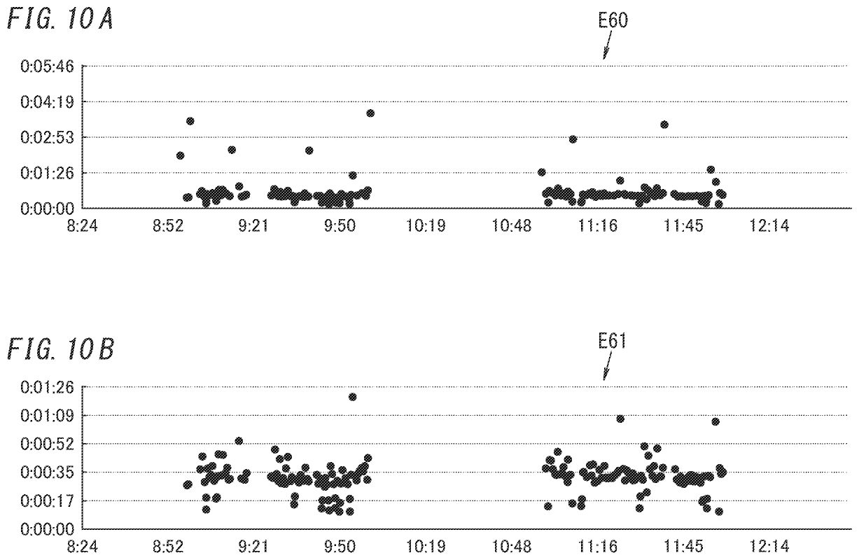

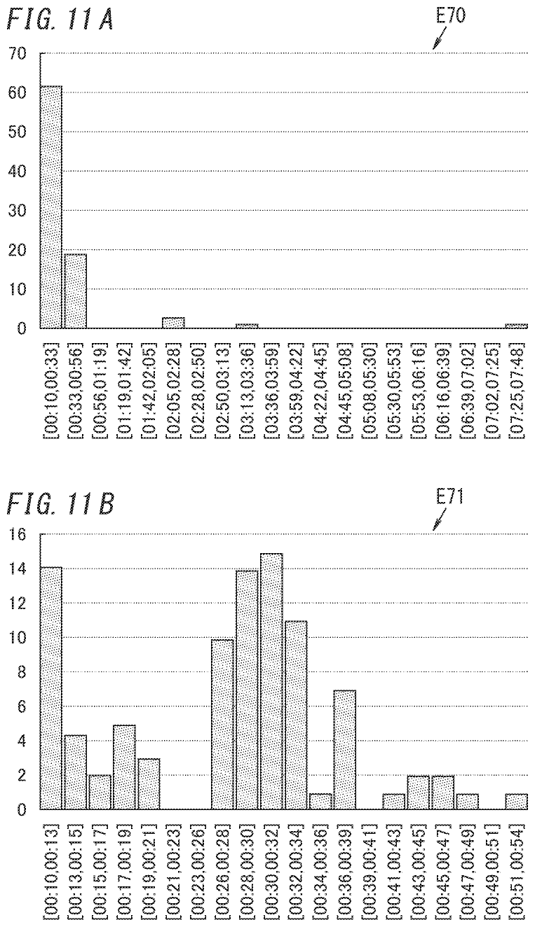

Specifically, a scatter diagram E60 shown in FIG. 10A and a scatter diagram E61 shown in FIG. 11B are displayed as the sixth statistical data on the display section 50. As illustrated in FIG. 10A, the scatter diagram E60 is displayed on the display section 50, where the ordinate represents the working hours for the first subtask which the person B1 carries out and the abscissa represents the time. As illustrated in FIG. 10B, the scatter diagram E61 is displayed on display section 50, were the ordinate represents the working hours for the second subtask which the person B1 carries out and the abscissa represents the time. FIGS. 10A and 10B each show an example of the sixth statistical data, where a time zone from about 8:20 to about 12:15 is the specific time zone.

In a similar manner to the case of generating the second statistical data, the processing unit 11 calculates the working hours of the person B1 in accordance with the first time information and the second time information. In this embodiment, the processing unit 11 acquires, as the second time information, second time information (hereinafter referred to also as “first information”) in which the movement of the first jig is defined as the prescribed motion and second time information (hereinafter referred to also as “second information”) in which the movement of the second jig is defined as the prescribed motion. Thus, the processing unit 11 calculates, in accordance with the first time information and the first information, the working hours for the first subtask which the person B1 carries out. Moreover, the processing unit 11 calculates, in accordance with the first time information and the second information, the working hours for the second subtask which the person B1 carries out. That is, the working hours calculated by the processing unit 11 are divided into working hours for the first subtask and working hours for the second subtask. In other words, the work information includes pieces of information regarding respective subtasks obtained by dividing the work. Then, the processing unit 11 generates the sixth statistical data in accordance with the working hours thus calculated for the first subtask and the working hours thus calculated for the second subtask.

The administrator views the sixth statistical data by using the terminal 5, and thereby, the administrator can know the variations in the working hours for the first subtask and the second subtask which the person B1 carries out. That is, the administrator can know the variations in the working hours for each of a plurality of subtasks obtained by dividing the work. In the example shown in FIGS. 10A and 10B, the administrator can know that the occurrence frequency of the anomalous value is higher in the first subtask than in the second subtask and that the variations in the working hours are greater in the second subtask than in the first subtask.

(4.7) Seventh Statistical Data

Seventh statistical data represents variations in the working hours of the person B1 in a specific time zone in one day. Specifically, a histogram E70 shown in FIG. 1I A and a histogram E71 shown in FIG. 11B are displayed as the seventh statistical data on the display section 50.

As illustrated in FIGS. 11A and 11B, the histograms E70 and E71 are each displayed on the display section 50, where the ordinate represents the frequency of work carried out by the person B1 and the abscissa represents the class of the working hours of the person B1. For example, in FIG. 11A, the frequency corresponding to a class in which working hours for work of all units of work carried out by the person B1 fall within the range from 10 seconds to 33 seconds is about 60. In this embodiment, the histogram E70 is directed to the entire working hours including anomalous values of working hours, whereas the histogram E71 is directed to working hours except for anomalous values. In the example shown in FIG. 11B, working hours longer than 54 seconds are defined as anomalous values and are excluded. Note that although omitted from FIGS. 11A and 11B, an average value of the working hours and a median value of the working hours are displayed on the display section 50 by character strings along the histograms E70 and E71.

In a similar manner to the case of generating the second statistical data, the processing unit 11 calculates the working hours of the person B1 in accordance with the first time information and the second time information and generates the seventh statistical data in accordance with the working hours thus calculated.

The administrator views the seventh statistical data by using the terminal 5, and thereby, the administrator can know the variations in the working hours of the person B1 and/or know the occurrence of any unusual event in the work in a similar manner to the case where the administrator views the fourth statistical data.

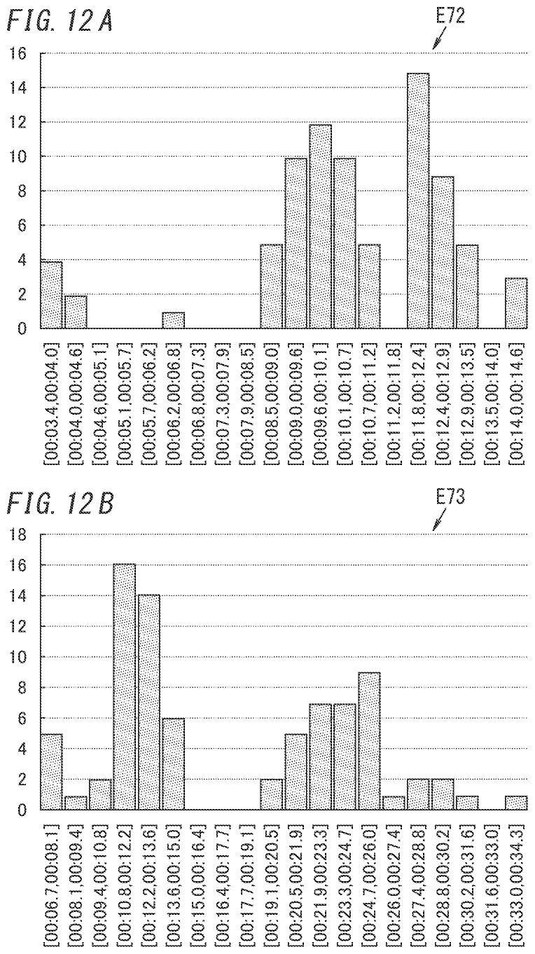

In this embodiment, the work which the person B1 carries out is assumed to include the first subtask and the second subtask in a similar manner to the example of the sixth statistical data. In this case, the administrator may give a prescribed operation to the terminal 5 to view the seventh statistical data from a different aspect. Specifically, the histogram E72 about the working hours for the first subtask shown in FIG. 12A and the histogram E73 about the working hours for the second subtask shown in FIG. 12B may be displayed as the seventh statistical data on the display section 50. The histograms E72 and E73 are each displayed on the display screen 50 with the anomalous values being removed.

As illustrated in FIG. 12A, the histograms E72 is displayed on the display section 50, where the ordinate represents the frequency of the first subtask carried out by the person B1 and the abscissa represents the class of the working hours of the first subtask carried out by the person B1. As illustrated in FIG. 12B, the histograms E73 is displayed on the display section 50, where the ordinate represents the frequency of the second subtask carried out by the person B1 and the abscissa represents the class of the working hours of the second subtask carried out by the person B1. Note that although omitted from FIG. 12A, an average value of the working hours for the first subtask and a median value of the working hours for the first subtask are displayed on the display section 50 by character strings along the histogram E72. In a similar manner, although omitted from FIG. 12B, an average value of the working hours for the second subtask and a median value of the working hours for the second subtask are displayed on the display section 50 by character strings along the histogram E73.

In the above-described case, the administrator can know the variations in the working hours for the first subtask and the second subtask carried out by the person B1. That is, the administrator can know the variations in the working hours for each of a plurality of subtasks obtained by dividing the work.

(4.8) Eighth Statistical Data

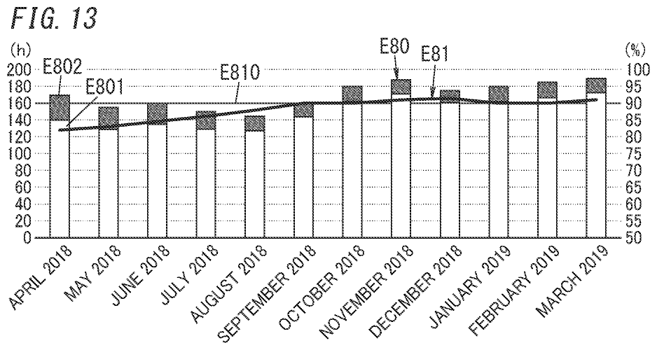

Eighth statistical data represents a transition of the activity time of the person B1 per month. Specifically, as illustrated in FIG. 13, a bar graph E80 and a line graph E81 are displayed as the eighth statistical data on the display section 50. The bar graph E80 is displayed on the display section 50, where the ordinate on the left represents the activity time and the abscissa represents months of the year. The line graph E81 is displayed on the display section 50, where the ordinate on the right represents the operating ratio and the abscissa represents the months of the year. As used herein, the “operating ratio” is a ratio of the attendance time to the activity time of the person B1.

The bar graph E80 is displayed on the display section 50 in the form of a bar graph including a first area E801 and a second area E802. The first area E801 represents the attendance time of the person B1. The second area E802 represents the absence time of the person B1. The line graph E81 is displayed on the display section 50 in the form of a line graph including a straight line E810. The straight line E810 represents a target value of the operating ratio.

In a similar manner to the case of generating the second statistical data, the processing unit 11 calculates the attendance time and the absence time of the person B1 in accordance with the first time information and generates the eighth statistical data in accordance with the attendance time and the absence time thus calculated.

The administrator views the eighth statistical data by using the terminal 5, and thereby, the administrator can know the activity time of the person B1. Moreover, the administrator views the eighth statistical data by using the terminal 5, and thereby, the administrator can take a measure such as improving the activity of the person B1 so that the operating ratio of the person B1 reaches the target value.

Advantages of the process management system 100 of the present embodiment will be described below in comparison with a process management method of a comparative example. In the process management method of the comparative example, a supervisor who supervises the work carried out by a person exists, and the supervisor measures, by using, for example, a stopwatch, an amount of time required for the person to carry out the work and/or captures images of the work carried out by the person by using, for example, a video camera. Moreover, in the process management method of the comparative example, the supervisor sums up and analyzes the measured and captured data. In the process management method of the comparative example, the supervisor has to continuously supervise the work carried out by a person and/or sum up and analyze the measured and captured data, and therefore, staff have to be assigned to this work, which may increase a staff cost. Moreover, in the process management method of the comparative example, the supervisor is present around the work area of a person, and therefore, the person may become conscious of the supervisor, may easily feel stress, and can hardly concentrate on the work.

In contrast, the work information on work which the person B1 repeatedly carries out in the work area A1 is acquired in the present embodiment in accordance with the first time information and the second time information. Thus, the present embodiment has the advantage that the state of the work which the person B1 carries out is more easily known than in the case where only the amount of motion time of the production facility (including the jig C1) is acquired and than in the process management method of the comparative example.

That is, in the present embodiment, the first time information and the second time information can be acquired from the sensing results by the first sensor 1 and the second sensor 2 installed in the work area A1. Thus, unlike the process management method of the comparative example, the present embodiment can acquire data necessary for knowing the state of the work which the person B1 carries out without disposing a supervisor around the work area. Moreover, the present embodiment can acquire work information by the processing unit 11 in accordance with the first time information and the second time information thus acquired. Unlike the process management method of the comparative example, the present embodiment does thus not have to assign staff to supervising work, sum up work, and analysis work, and therefore, the state of the work carried out by the person B1 can be easily known, and in addition, a staff cost can be reduced. Moreover, unlike the process management method of the comparative example, the present embodiment does not have to dispose a supervisor, and therefore, the present embodiment has the advantage that the person B1 is less likely to feel stress and can easily concentrate on the work.

Moreover, the process management method of the comparative example has low immediacy because the administrator can view analyzed data only after the supervisor completes the analysis work. In contrast, the present embodiment can acquire the work information by the processing unit 11 by at least acquiring the first time information and the second time information, and therefore, the state of the work which the person B1 carries out can be known in real time.

### (5) Variation

The embodiment described above is merely an example of various embodiments of the present disclosure. The embodiment described above may be modified in various ways depending on design and the like as long as the object of the present disclosure is achieved. Functions similar to those of the process management system 100 may be implemented by a process management method, a computer program, a non-transitory storage medium storing a computer program, or the like.

A process management method according to one aspect includes a step of acquiring first time information on an amount of time for which the person B1 is present in the work area A1. The process management method includes a step of acquiring second time information on an amount of motion time for which the person B1 makes a prescribed motion in the work area A1. The process management method includes a step of acquiring, in accordance with the first time information and the second time information, work information on work which the person B1 repeatedly carries out, the work including the prescribed motion.

A program according to one aspect is a program configured to cause one or more processors to execute the process management method.

Variations of the embodiment described above will be described below. The variations described below are applicable accordingly in combination.

The process management system 100 according to the present disclosure includes a computer system. The computer system includes, as principal hardware components, a processor and a memory. The functions as the process management system 100 according to the present disclosure may be implemented by making the processor execute a program stored in the memory of the computer system. The program may be stored in the memory of the computer system in advance, may be provided via a telecommunications network, or may be provided as a non-transitory recording medium such as a computer system-readable memory card, optical disc, or hard disk drive storing the program. The processor of the computer system may be made up of a single or a plurality of electronic circuits including a semiconductor integrated circuit (IC) or a largescale integrated circuit (LSI). The integrated circuit such as IC or LSI mentioned herein may be referred to in another way, depending on the degree of the integration and includes integrated circuits called system LSI, very-large-scale integration (VLSI), or ultra-large-scale integration (ULSI). Further, a FPGA, which is programmable after fabrication of the LSI, or a logical device which allows reconfiguration of connections in LSI or reconfiguration of circuit cells in LSI may be adopted as the processor. The plurality of electronic circuits may be collected on one chip or may be distributed on a plurality of chips. The plurality of chips may be collected in one device or may be distributed in a plurality of devices. As mentioned herein, the computer system includes a microcontroller including one or more processors and one or more memories. Thus, the microcontroller is also composed of one or more electronic circuits including a semiconductor integrated circuit or a large-scale integrated circuit.

Moreover, collecting the plurality of functions in the process management system 100 in one server is not an essential configuration of the process management system 100. That is, the components of the process management system 100 may be distributed in a plurality of servers. Alternatively, at least some functions of the process management system 100 may be implemented by cloud (cloud computing) or the like.

In the embodiment described above, the process management system 100 is not limited to the aspect implemented by a server but may be implemented by installing an application on the terminal 5.

In the embodiment described above, a camera configured to capture images of the work area A1 may be installed around the work area A1. The communicator 10 of the process management system 100 may acquire the images (still images and/or moving images) captured by the camera, for example, via the gateway 4 and the network N1. The processing unit 11 may associate the images thus acquired with the work information. That is, the work information may be associated with images obtained by capturing the work area A1. This aspect has the advantage that the state of the work which the person B1 carries out can be visually easily known. For example, when the administrator views the statistical data by using the terminal 5 and thus finds an anomalous value of the working hours, the administrator can search for the cause of the occurrence of the anomalous value by viewing images in a time zone in which the anomalous value has been generated.

In the embodiment described above, a method for identifying the people B1 from each other is not limited to the aspect in which the people B1 are identified based on the identifiers of the first sensor 1 and the second sensor 2 but may be an aspect in which Intra-body Communication using the people B1 as transmission media, identification tags held by the people B1, or the like is used to identify the people B1.

In the embodiment described above, the second sensor 2 is not limited to the aspect in which the movement of the jig C1 is detected to detect the prescribed motion, but the second sensor 2 may be configured to detect the prescribed motion by detecting the movement of a person B1 using the jig C1. For example, the worktable A11 is assumed to have a space which part of the person B1 enters only when the person B1 uses the jig C1. In this case, the second sensor 2 detects the presence or absence of an object (e.g., the arm of the person B1) in the space, and thereby, the second sensor 2 can detect the prescribed motion made by the person B1 who uses the jig C1. Thus, the prescribed motion is desirably detected as specific work or a specific motion in a process of the work but may be detected as a specific motion performed separately from such specific work or motion.

In the embodiment described above, the time stamp which is to be associated with the sensing result by the first sensor 1 is not necessarily added by the gateway 4 but may be added by the first sensor 1 or the communicator 10. That is, the time stamp may be added by the communicator 10 when the communicator 10 acquires the sensing result by the first sensor 1, or the time stamp may be added to the sensing result when the first sensor 1 detects the presence or absence of the person B1. Moreover, the time stamp which is to be associated with the sensing result by the second sensor 2 is not necessarily added by the gateway 4 but may be added by the second sensor 2, the relay 20, or the communicator 10. That is, the time stamp may be added by the communicator 10 when the communicator 10 acquires the sensing result by the second sensor 2, the time stamp may be added to the sensing result when the second sensor 2 detects the motion, or the time stamp may be added by the relay 20 when the relay 20 acquires the sensing result by the second sensor 2. Moreover, the time stamp which is to be associated with the sensing result by the third sensor 3 is not necessarily added by the gateway 4 but may be added by the third sensor 3 or the communicator 10. That is, the time stamp may be added by the communicator 10 when the communicator 10 acquires the sensing result by the third sensor 3, or the time stamp may be added to the sensing result when the third sensor 3 detects the work status.

In the embodiment described above, the first acquirer 101 may acquire the attendance time and the absence time of the person B1 from the first sensor 1 without acquiring the time stamp. In this case, the attendance time and the absence time of the person B1 are at least obtained by the first sensor 1 or the gateway 4. Similarly, the second acquirer 102 may acquire an amount of time required for the prescribed motion from the second sensor 2 without acquiring the time stamp. In this case, the amount of time required for the prescribed motion is at least obtained by the second sensor 2, the relay 20, or the gateway 4.

In the embodiment described above, the first sensor 1 is not limited to have the configuration in which the light emitting unit and the light receiving unit are integrated with each other but may have a configuration in which the light emitting unit and the light receiving unit are accommodated in different housings. Moreover, the configuration of the first sensor 1 is not limited to the configuration in which the light receiving unit detects reflected light, but the configuration of the first sensor 1 may be a configuration, a so-called transmitting-type photoelectric sensor, in which the first sensor 1 detects the presence of the person B1 when detecting interruption of light projected from the light emitting unit.

In the embodiment described above, the first sensor 1 may transmit its sensing result to the gateway 4 by wired communication. Similarly, the second sensor 2 may transmit its sensing result to the gateway 4 by wired communication.

In the embodiment described above, the second sensor 2 may include a wireless communication module which performs wireless communication with the gateway 4. In this aspect, the second sensor 2 can transmit the sensing result to the gateway 4 without using the relay 20. Thus, in this aspect, the relay 20 is unnecessary.

In the embodiment described above, each of the first sensor 1, the second sensor 2, and the third sensor 3 may have an aspect in which wireless communication with the communicator 10 of the process management system 100 is performed via the network N1 without using the gateway 4. In this aspect, the gateway 4 is unnecessary.

In the embodiment described above, the process management system 100 can acquire work information by the processing unit 11 by at least acquiring a sensing result from each of the first sensor 1 and the second sensor 2. Thus, in the embodiment described above, the third sensor 3 does not have to be installed in the facility.

In the embodiment described above, the jig C1 is not limited to the toggle clamp but is at least an aspect used by the person B1 for each unit of work. For example, the jig C1 may be an electric screwdriver. In this case, the second sensor 2 may have an aspect in which the second sensor 2 detects the magnitude of a current flowing through the jig C1 to determine whether or not the jig C1 is in a motion state. For example, the second sensor 2 is a current sensor such as a current transformer and is attached to a power supply cable of the jig C1 to detect the current flowing through the jig C1.

### SUMMARY

As described above, a process management system (100) of a first aspect includes a first acquirer (101), a second acquirer (102), and a processing unit (11). The first acquirer (101) is configured to acquire first time information on an amount of time for which a person (B1) is present in a work area (A1). The second acquirer (102) is configured to acquire second time information on an amount of motion time for which the person (B1) makes a prescribed motion in the work area (A1). The processing unit (11) is configured to acquire, in accordance with the first time information and the second time information, work information on work which the person (B1) repeatedly carries out, the work including the prescribed motion.

This aspect has the advantage that the state of the work which the person (B1) carries out can be easily known.

In a process management system (100) according to a second aspect referring to the first aspect, the second acquirer (102) is configured to acquire, as the second time information, an amount of motion time of a jig (C1) used in the work area (A1).

This aspect has the advantage that the second time information is more easily acquired than in the case where the motion of the person (B1) is detected to acquire the second time information.

In a process management system (100) according to a third aspect referring to the first or second aspect, at least one of the first time information or the second time information includes a time stamp regarding an acquisition time.

This aspect has the advantage that a time zone in which the work is carried out by the person (B1) is easily known.

A process management system (100) of a fourth aspect referring to any one of the first to third aspects further includes an outputter (104) configured to output the work information as data to be visually displayed on a display section (50).

This aspect has the advantage that the work which the person (B1) carries out is easily improved by the data output from the outputter (104) being viewed by using the display section (50) in a site including the work area (A1).

In a process management system (100) of a fifth aspect referring to any one of the first to fourth aspects, the processing unit (11) is configured to individually acquire the work information on a per-person (B1) basis.

This aspect has the advantage that even when people (B1) carry out units of work, the state of the units of work is easily known on a per-person (B1) basis.

In a process management system (100) of a sixth aspect referring to any one of the first to fifth aspects, the processing unit (11) is configured to execute statistical processing in accordance with the work information.

This aspect has the advantage that the state of the work which the person (B1) carries out made easier to be known with reference to data after the statistical processing.

In a process management system (100) of a seventh aspect referring to any one of the first to sixth aspects, the work information is associated with an image obtained by capturing the work area (A1).

This aspect has the advantage that the state of the work which the person (B1) carries out can be visually easily known.

In a process management system (100) of an eighth aspect referring to any one of the first to seventh aspects, the work information includes pieces of information regarding respective subtasks obtained by dividing the work.

This aspect has the advantage that the state of the work which the person (B1) carries out can be easily known in detail for each of the subtasks.

A process management system (100) of a ninth aspect referring to any one of the first to eighth aspects further includes a first sensor (1) and a second sensor (2). The first sensor (1) is configured to detect a presence or absence of the person (B1) in the work area (A1). The second sensor (2) is configured to detect the prescribed motion.

This aspect has the advantage that the state of the work which the person (B1) carries out can be easily known.

A process management method according to a tenth aspect includes a step of acquiring first time information on an amount of time for which a person (B1) is present in a work area (A1). The process management method includes a step of acquiring second time information on an amount of motion time for which the person (B1) makes a prescribed motion in the work area (A1). The process management method includes a step of acquiring, in accordance with the first time information and the second time information, work information on work which the person (B1) repeatedly carries out, the work including the prescribed motion.

This aspect has the advantage that the state of the work which the person (B1) carries out can be easily known.

A program of an eleventh aspect is a program configured to cause one or more processors to execute the process management method of the tenth aspect.

This aspect has the advantage that the state of the work which the person (B1) carries out can be easily known.

The configurations according to the second to ninth aspects are not configurations essential for the process management system (100) and may thus be accordingly omitted.

By the way, in the process management system (100) of the first aspect, the processing unit (11) may set, by machine learning based on a history of, for example, working hours thus acquired, the threshold based on which an anomalous value of the working hours is to be determined. That is, the threshold does not necessarily have to be manually set by the administrator but may be automatically set by the processing unit (11). In this case, the process management system does not have to include the first acquirer (101) or the second acquirer (102), and in addition, the process management system does not have to have the function of acquiring the work information by the processing unit (11). That is, a process management system of a twelfth aspect includes an acquirer and a processing unit (11). The acquirer is configured to acquire working hours required for the work which a person (B1) repeatedly carries out. The processing unit (11) is configured to set, in accordance with a history of the working hours acquired by the acquirer, a threshold based on which an anomalous value of the working hours is to be determined.

Moreover, in the process management system (100) of the first aspect, the processing unit (11) may display some of parameters included in the work information as pieces of time series data on the display section (50) in accordance with, for example, the history of the work information thus acquired. As used herein, the parameter is, for example, the attendance time, the absence time, the working hours, or the non-working hours of the person (B1). In this case, the process management system does not have to include the first acquirer (101) or the second acquirer (102), and in addition, the process management system does not have to have the function of acquiring the work information by the processing unit (11). That is, a process management system of a thirteenth aspect includes an acquirer and a processing unit (11). The acquirer is configured to acquire work information regarding work which a person (B1) repeatedly carries out. The processing unit (11) is configured to display, in accordance with a history of the work information thus acquired, some of parameters included in the work information as pieces of time-series data on the display section (50).

### REFERENCE SIGNS LIST

1 FIRST SENSOR
2 SECOND SENSOR
50 DISPLAY SECTION
100 PROCESS MANAGEMENT SYSTEM
101 FIRST ACQUIRER
102 SECOND ACQUIRER
104 OUTPUTTER
11 PROCESSING UNIT
A1 WORK AREA
B1 PERSON
C1 JIG

1. A process management system, comprising:
a first acquirer configured to acquire first time information on an amount of time for which a person is present in a work area;
a second acquirer configured to acquire second time information on an amount of motion time for which the person makes a prescribed motion in the work area; and
a processing unit configured to acquire, in accordance with the first time information and the second time information, work information on work which the person repeatedly carries out, the work including the prescribed motion.

2. The process management system of claim 1, wherein
the second acquirer is configured to acquire, as the second time information, an amount of motion time of a jig used in the work area.

3. The process management system of claim 1, wherein
at least one of the first time information or the second time information includes a time stamp regarding an acquisition time.

4. The process management system of claim 1, further includes
an outputter configured to output the work information as data to be visually displayed on a display section.

5. The process management system according to claim 1, wherein
the processing unit is configured to individually acquire the work information on a per-person basis.

6. The process management system of claim 1, wherein
the processing unit is configured to execute statistical processing in accordance with the work information.

7. The process management system of claim 1, wherein
the work information is associated with an image obtained by capturing the work area.

8. The process management system of claim 1, wherein
the work information includes pieces of information regarding respective subtasks obtained by dividing the work.

9. The process management system of claim 1, further comprising:
a first sensor configured to detect a presence or absence of the person in the work area; and
a second sensor configured to detect the prescribed motion.

10. A process management method, comprising:
acquiring first time information on an amount of time for which a person is present in a work area;
acquiring second time information on an amount of motion time for which the person makes a prescribed motion in the work area; and
acquiring, in accordance with the first time information and the second time information, work information on work which the person repeatedly carries out, the work including the prescribed motion.

11. A program configured to cause one or more processors to execute the process management method of claim 10.
